(19) United States
(12) Patent Application Publication
(10) Pub. No.: US 2026/0027945 A1
(43) Pub. Date: Jan. 29, 2026

(54) HANDLING MACHINE

(71) Applicant: MANITOU BF, ANCENIS (FR)

(72) Inventors: Maurice BESSEAU, ANCENIS (FR); Alexis POUSSET, ANCENIS (FR)

(21) Appl. No.: 19/259,689

(22) Filed: Jul. 3, 2025

(30) Foreign Application Priority Data
Jul. 23, 2024 (FR) 2408107

(51) Int. Cl. B60L 58/18; B60L 1/00; B60L 50/60; B60L 50/64; B60L 58/12; B66C 23/38; B66F 9/075; E02F 3/28

(52) U.S. Cl. CPC B60L 58/18; B60L 1/003; B60L 50/64; B60L 50/66; B60L 58/12; B66F 9/07531; B60L 2200/42; B60L 2240/545; B66C 23/38; E02F 3/283

(57) ABSTRACT

The invention relates to a handling machine (1) comprising:
a chassis (2);
a lifting arm (20);
a front axle (3) and a rear axle (4);
a cab (6) which is positioned between the front axle (3) and the rear axle (4) and on a first side of the lifting arm (20);
at least one electric motor;
a first and a second electrical energy storage unit which are connected to the at least one electric motor and fixed to the chassis (2) on either side of the lifting arm (20), the first electrical energy storage unit (40A) being positioned to the rear of the cab (6) on the first side of the lifting arm (20) and the second electrical energy storage unit (40B) being arranged on a second side of the lifting arm (20), opposing the first side, at least partially opposite the first electrical energy storage unit in a transverse direction at right-angles to the median longitudinal plane.

### TECHNICAL FIELD

The invention relates to a handling machine comprising an electric motor and at least one electrical energy storage unit

### TECHNOLOGICAL BACKGROUND

A handling machine is disclosed in the document CN 104500113, comprising a chassis, a lifting arm which is pivotably mounted on the chassis, a front axle and a rear axle which are fixed to the chassis, and a cab which is fixed to the chassis and is positioned between the front axle and the rear axle.

The handling machine also comprises an electric motor which is coupled to one of the axles, a battery carrier which is arranged behind the chassis of the machine and a battery which is plugged onto the battery carrier.

Such an arrangement of the battery has a negative impact on the compactness of the handling machine, in particular in the case of handling machines of small size.

### SUMMARY OF THE INVENTION

One idea on which the invention is based is to reduce the effect of the batteries on the compactness of the handling machine, without otherwise impairing the lateral balance of the machine.

A further idea on which the invention is based is to select a position which is easily accessible for the batteries while limiting the risk of impacts thereon.

According to one embodiment, the invention provides a handling machine comprising:
a chassis;
a lifting arm which is pivotably mounted on the chassis in a median longitudinal plane;
a front axle and a rear axle which are fixed to the chassis;
a cab which is designed to accommodate a driver, said cab being fixed to the chassis and being positioned between the front axle and the rear axle and on a first side of the lifting arm;
at least one electric motor; and
a first and a second electrical energy storage unit which are connected to the at least one electric motor and fixed to the chassis on either side of the lifting arm, the first electrical energy storage unit being positioned to the rear of the cab on the first side of the lifting arm and the second electrical energy storage unit being arranged on a second side of the lifting arm, opposing the first side, at least partially opposite the first electrical energy storage unit in a transverse direction at right-angles to the median longitudinal plane.

As a result of these features, the position of the first and second electrical energy storage units makes it possible, on the one hand, to reduce the effect of the batteries on the compactness of the handling machine and, on the other hand, to preserve the lateral balance of the machine. Moreover, the position of the batteries at the rear of the vehicle, without protruding, enables them to be accessible while protecting them from numerous impacts during the use of the machine.

According to the embodiments, such a machine can comprise one or more of the following features.

According to one embodiment, the at least one electric motor is coupled to at least one of the front and rear axles.

According to one embodiment, the first and second electrical energy storage units have a mass distribution which is substantially balanced relative to the median longitudinal plane.

According to one embodiment, the mass distribution is 50 to 60% on the side of the first electrical energy storage unit and 40 to 50% on the side of the second electrical energy storage unit.

According to one embodiment, the mass distribution is 60% on the side of the first electrical energy storage unit and 40% on the side of the second electrical energy storage unit.

According to one embodiment, the mass distribution is 50% on the side of the first electrical energy storage unit and 50% on the side of the second electrical energy storage unit.

According to one embodiment, the mass distribution is 40% on the side of the first electrical energy storage unit and 60% on the side of the second electrical energy storage unit.

Due to such a distribution, the battery elements have a relatively neutral effect, or even an advantageous effect, on the lateral balance of the machine. Moreover, a lateral balance of the machine which is generally acceptable can be obtained by a balanced arrangement of the other components of the machine. This balanced arrangement can also be implemented in different ways.

According to one embodiment, the first and second electrical energy storage units each comprise a plurality of electrolytic cells, the first electrical energy storage unit or the second electrical energy storage unit comprising a battery management system which is configured to monitor and control the electrolytic cells of the first and second electrical energy storage units.

According to one embodiment, the battery management system is incorporated in the first electrical energy storage unit, the number of electrolytic cells of the second electrical energy storage unit being greater than the number of electrolytic cells of the first electrical energy storage unit.

According to one embodiment, the battery management system is incorporated in the second electrical energy storage unit, the number of electrolytic cells of the first electrical energy storage unit being greater than the number of electrolytic cells of the second electrical energy storage unit.

According to one embodiment, the first electrical energy storage unit comprises a plurality of electrolytic cells and the second electrical energy storage unit comprises a battery management system which is configured to monitor and control the electrolytic cells of the first electrical energy storage unit.

According to one embodiment, the second electrical energy storage unit comprises a plurality of electrolytic cells and the first electrical energy storage unit comprises a battery management system which is configured to monitor and control the electrolytic cells of the second electrical energy storage unit.

According to one embodiment, the first and second electrical energy storage units each comprise at least one temperature sensor and at least one device for measuring the charging state.

According to one embodiment, the first electrical energy storage unit is located in a longitudinal direction, parallel to the median longitudinal plane, between the cab and a rear end of the chassis.

According to one embodiment, the first electrical energy storage unit is located in the transverse direction between the lifting arm and a lateral edge of the chassis.

According to one embodiment, the handling machine comprises a box which is configured to receive a plurality of pieces of equipment, the box being positioned between the front axle and the rear axle and on the second side of the lifting arm.

According to one embodiment, the second electrical energy storage unit is located in a longitudinal direction, parallel to the median longitudinal plane, between the box and a rear end of the chassis.

According to one embodiment, the second electrical energy storage unit is located in the transverse direction between the lifting arm and a lateral edge of the chassis.

According to one embodiment, the electric motor is an electric propulsion motor which is configured for the propulsion of the handling machine, and the handling machine comprises an electric actuating motor which is configured to actuate the lifting arm, the first and second electrical energy storage units being connected to the electric actuating motor and the electric propulsion motor.

According to one embodiment, the handling machine comprises a box which is configured to receive a plurality of pieces of equipment, the box being positioned between the front axle and the rear axle and on the second side of the lifting arm, the electric propulsion motor being located between the front axle and the rear axle below the lifting arm and the electric actuating motor being located in the box.

According to one embodiment, the handling machine comprises at least one transmission which couples said at least one electric motor to at least one of the front axle and the rear axle.

The machine can comprise one drive axle or two drive axles for its propulsion. The drive axle can be a front axle or a rear axle.

For driving an axle, the machine can use one or more electric motors coupled by a mechanical transmission chain to the axle, in other words an electromechanical drive.

The mechanical transmission chain can comprise one or more elements selected from the group consisting of: a reduction gear train, a transmission shaft and a cardan joint.

Alternatively, for driving an axle, the machine can use one or more electric motors coupled by a hydraulic transmission chain to the axle, in other words an electrohydraulic drive.

The hydraulic transmission chain can comprise a hydraulic pump driven by the electric motor and at least one hydraulic motor driven by a hydraulic flow generated by the hydraulic pump. The hydraulic transmission chain can be a hydrostatic transmission chain, namely in a closed circuit. The hydraulic pump and the electric motor can share other hydraulic functions of the machine, such as a hydraulic actuating function of the lifting arm or the like.

If required, the machine can use two independent drives or a common drive for driving two axles. The two independent drives can be of different types, for example an electromechanical drive and an electrohydraulic drive, or of identical type, for example two electromechanical drives.

According to one embodiment, the first and second electrical energy storage units are connected to the electric propulsion motor via a first electric speed variator.

According to one embodiment, the first and second electrical energy storage units are connected to the electric actuating motor via a second electric speed variator.

For actuating the lifting arm, the machine can comprise one or more electric actuators, namely an electric actuation, for example via an electric actuating cylinder and/or one or more hydraulic actuators supplied by one or more pumps driven by one or more electric motors, namely an electrohydraulic actuation, for example via a hydraulic actuating cylinder.

A plurality of actuators of different types, for example at least one electric actuator and at least one hydraulic actuator, or of identical types, for example a plurality of hydraulic actuators, can be provided to actuate different movements or degrees of freedom of the lifting arm.

For example, the different movements can be selected from the group consisting of: a pivoting movement, an extension-retraction movement and an inclination movement of an implement carrier.

According to one embodiment, the at least one electric actuating motor comprises at least one electric actuating cylinder which is configured to actuate at least one movement of the lifting arm.

According to one embodiment, the machine further comprises a hydraulic pump which is coupled to the electric actuating motor and at least one hydraulic actuator which is supplied by the hydraulic pump in order to actuate at least one movement of the lifting arm.

Independent hydraulic pumps can be used or a common hydraulic pump can be used in the case of an electrohydraulic actuation of one or more movements of the lifting arm and an electrohydraulic drive of one or more axles. The independent hydraulic pumps can be driven by a plurality of respective electric motors.

In all cases, the first and second electrical energy storage units can be connected electrically to a single electric motor or to a plurality of electric motors in order to provide power to said electric motor(s), for the propulsion of the chassis and for the actuation of the lifting arm.

According to one embodiment, the handling machine is a telescopic machine or a telescopic forklift truck, the lifting arm being a telescopic lifting arm. This type of machine is commonly called a “telehandler” in English.

### BRIEF DESCRIPTION OF THE FIGURES

The invention will be understood more clearly and further objects, details, features and advantages thereof will become more apparent during the course of the following description of several particular embodiments of the invention, provided solely in an illustrative and non-limiting manner, with reference to the accompanying drawings.

FIG. 1 shows a view from above of a handling machine according to one embodiment.

FIG. 2 shows a partial perspective view of a handling machine according to one embodiment.

FIG. 3 shows a perspective view of internal elements of a handling machine according to one embodiment, namely the axles, the longitudinal members and the first and second electrical energy storage units.

FIG. 4 shows a perspective view of the internal elements of a handling machine according to one embodiment, namely in particular the axles, the electric motors and the first and second electrical energy storage units.

### DESCRIPTION OF EMBODIMENTS

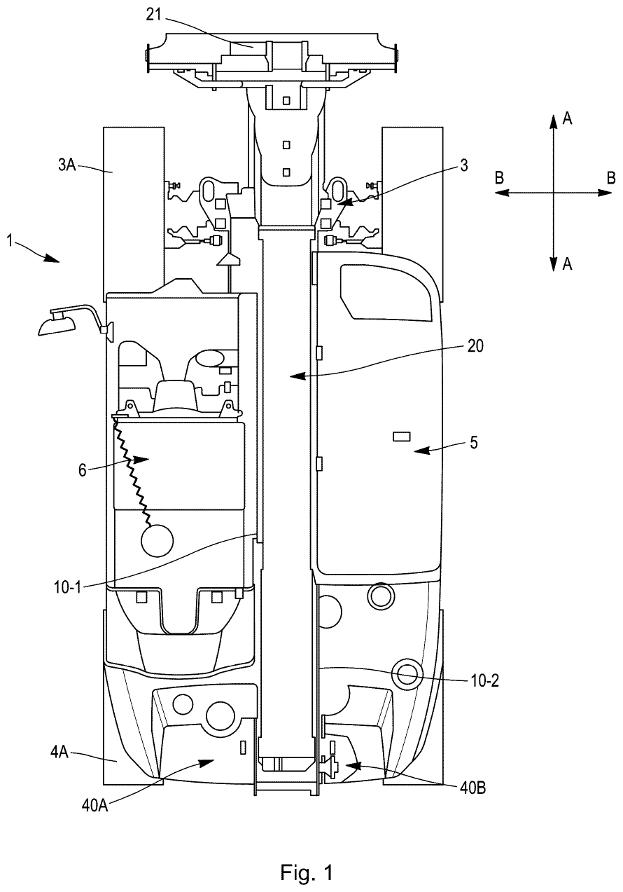

FIG. 1 is an overall perspective view of a handling machine 1, hereinafter denoted as “the machine 1” for simplicity. The machine 1 is produced in this case in the form of a telescopic forklift truck.

In the figures, the arrow A-A denotes a longitudinal direction of the machine 1, the arrow B-B denotes a transverse direction of the machine 1 and the arrow C-C denotes a vertical direction of the machine 1. The longitudinal direction A-A is a front-rear direction of the machine 1. The transverse direction B-B is a left-right direction of the machine 1 and is perpendicular to the longitudinal direction A-A. The vertical direction C-C is perpendicular to the longitudinal direction A-A and the transverse direction B-B.

The machine 1 comprises a chassis 2 and a lifting arm 20.

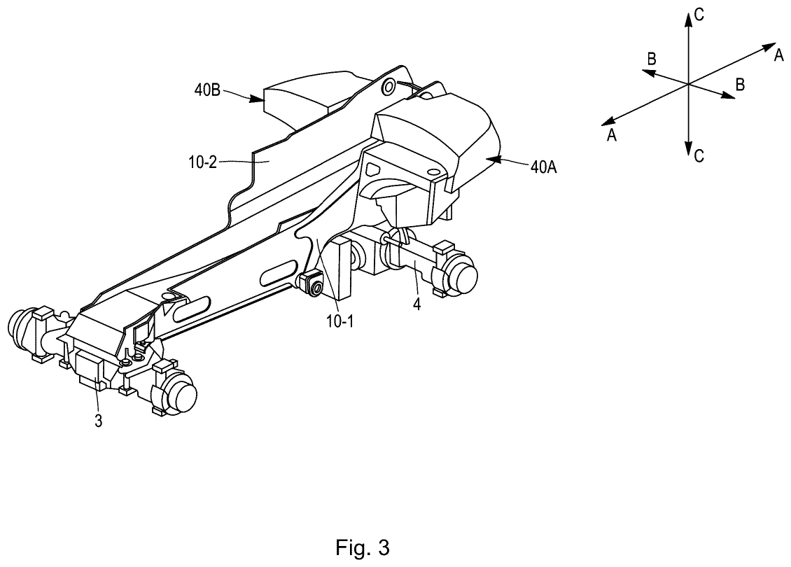

The chassis 2 comprises two longitudinal members 10-1 and 10-2 which are more clearly visible, in particular, in FIG. 3. The longitudinal members 10-1, 10-2 are generally flat metal parts parallel with one another and extending parallel to the longitudinal direction A-A in a plane parallel to a median longitudinal plane.

The chassis 2 is mobile and displaceable over the surface of the ground (not shown in the drawings) via a front axle 3 bearing two wheels 3A, one on the left and the other on the right, and a rear axle 4 bearing two wheels 4A, one on the left and the other on the right. The front axle 3 and the rear axle 4 are spaced apart in the longitudinal direction A-A.

As is more clearly visible in FIG. 1, in particular, the lifting arm 20 extends parallel to the longitudinal direction A-A, in the same manner as the longitudinal members 10-1, 10-2. The lifting arm 20 is articulated relative to the two longitudinal members 10-1, 10-2 between the two longitudinal members 10-1, 10-2 so as to be pivotably movable relative to two longitudinal members 10-1, 10-2 about a pivot axis. The pivot axis extends in the transverse direction B-B.

The lifting arm 20 can be implemented in different ways, in particular in the form of a plurality of telescopic sections as shown, or as a variant in the form of an arm of fixed length. One end of the lifting arm 20 opposing the pivot axis can bear a working implement or, as shown in FIG. 1, a modular implement carrier 21 capable of receiving working implements of several types, according to the prior art. “Working implement” denotes, for example, a pair of forks, a bucket, a winch, a claw, etc.

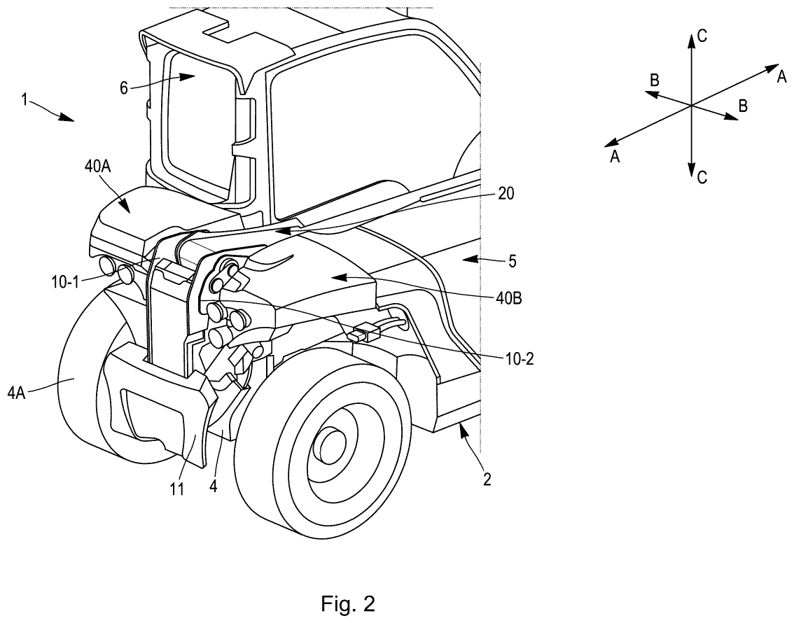

In FIG. 1 and in FIG. 2 it is also seen that the machine 1 comprises, on a first side of the lifting arm 20, a cab 6 in which a driver of the machine 1 can be seated and, on a second side of the lifting arm 20, a box 5 which is able to receive various pieces of equipment of the machine 1. The cab 6 protrudes from the longitudinal member 10-1 in a direction opposing the longitudinal member 10-2 and the box 5 protrudes from the longitudinal member 10-2 in a direction opposing the longitudinal member 10-1. More specifically, the box 5 is arranged along the longitudinal member 10-2 outside this longitudinal member 10-2 in the transverse direction B-B. While the drawings and the following description show the cab 6 arranged protruding from the longitudinal member 10-1 located to the left of the machine 1, and the box 5 arranged protruding from the longitudinal member 10-2 located to the right of the machine 1, it is obvious that the reverse arrangement is also possible, i.e. the arrangement of the longitudinal members 10-1, 10-2 can be reversed.

As shown, the cab 6 and the box 5 are arranged between the front axle 3 and the rear axle 4 in the longitudinal direction A-A.

Still with reference to FIGS. 1 and 2, the machine 1 comprises a first electrical energy storage unit 40A and a second electrical energy storage unit 40B fixed to the chassis 2 on either side of the lifting arm 20 in the transverse direction B-B. The first electrical energy storage unit 40A is positioned to the rear of the cab 6 on the first side of the lifting arm 20 and the second electrical energy storage unit 40B is arranged on the second side of the lifting arm 20, opposite the first electrical energy storage unit 40A in the transverse direction B-B.

The first and second electrical energy storage units 40A-40B are located vertically above the rear axle 4.

The first electrical energy storage unit 40A is fixed to the longitudinal member 10-1 and the second electrical energy storage unit 40B is fixed to the longitudinal member 10-2, as visible in FIG. 3.

As shown in FIG. 2, the first electrical energy storage unit 40A is located in the longitudinal direction A-A between the cab 6 and a rear end 11 of the chassis 2. The first electrical energy storage unit 40A is also located in the transverse direction B-B between the lifting arm 20 and a lateral edge of the chassis 2, in this case the left-hand lateral edge.

The second electrical energy storage unit 40B is in turn located in the longitudinal direction A-A between the box 5 and the rear end 11 of the chassis 2. The second electrical energy storage unit 40B is also located in the transverse direction B-B between the lifting arm 20 and a lateral edge of the chassis 2, in this case the right-hand lateral edge.

Generally, in this type of handling machine 1, a counterweight is placed at the rear of the machine 1. The advantageous position of the first and second electrical energy storage units 40A-40B at the rear of the machine 1 makes it possible to limit the mass required for such a counterweight, or even to remove such a counterweight completely.

The first and second electrical energy storage units 40A-40B are designed to supply electricity to at least one electric motor of the machine 1, as will be described hereinafter.

In one exemplary embodiment, each electrical energy storage unit 40A-40B comprises a housing enclosing a plurality of electrolytic cells generating the voltage at the terminals of the electrical energy storage unit 40A-40B. The electrical energy storage unit 40A-40B is, for example, of the lithium-ion type or the like. The first electrical energy storage unit 40A comprises in this case a battery management system (or BMS in English) which monitors and controls the charging and discharging of the electrolytic cells in a manner known per se. In this example, this battery management system monitors and controls the charging and discharging of the electrolytic cells of the first and second electrical energy storage units 40A-40B. In order to preserve a substantially balanced mass distribution between the electrical energy storage units 40A-40B, the numbers of electrolytic cells of the second electrical energy storage unit 40B is greater than the number of electrolytic cells of the first electrical energy storage unit 40A.

In a further exemplary embodiment, it is the second electrical energy storage unit 40A which comprises the common battery management system. In a further exemplary embodiment, each electrical energy storage unit 40A-40B comprises its own battery management system.

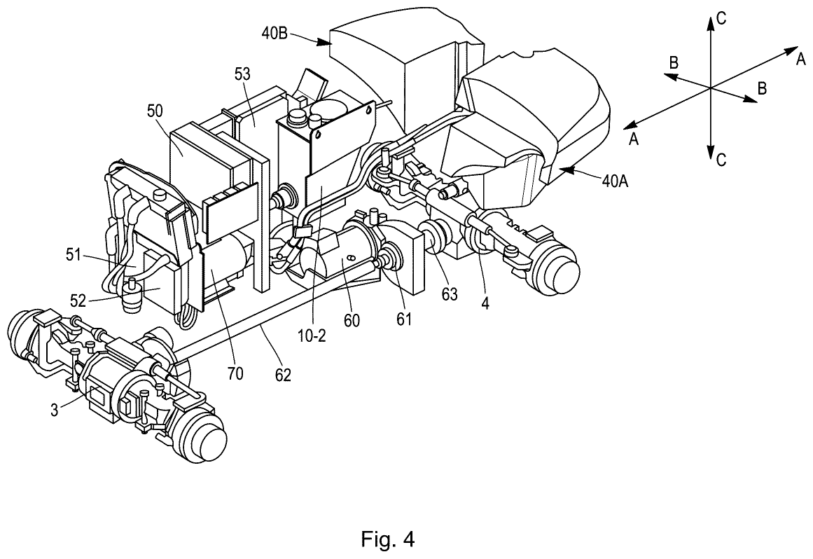

In FIGS. 3 and 4, the first and second electrical energy storage units 40A-40B have been shown with different shapes. These shapes are exemplary embodiments and other shapes could be envisaged.

With reference to FIG. 4, the machine 1 comprises a power distribution housing 50 which is connected to the electrical energy storage units 40A-40B and which is configured to supply, or not supply, power to the electrical components of the machine 1. Such power distribution housings are known per se, so that they are not described here in detail.

The power distribution housing 50 is connected, in particular, to an electric speed variator 51 which is in turn connected electrically to an electric propulsion motor 60 for the propulsion of the machine 1, and to an electric speed variator 52 which in turn is connected electrically to an electric actuating motor 70 for the actuation of the lifting arm 20. The electric speed variators 51 and 52 are in this case of the three-phase inverter type, i.e. receiving a direct voltage at the input and supplying a three-phase voltage at the output. Other electrical configurations are possible however.

As shown in FIG. 4, the electric propulsion motor 60 is located in the longitudinal direction A-A between the front axle 3 and the rear axle 4 and in the vertical direction C-C below the lifting arm 20. The electric actuating motor 70 is in turn received in the box 5.

In a manner not shown in FIG. 4, the power distribution housing 50 can also be connected electrically to further electrical equipment of the machine 1, in particular a heating module of the cab 6 and/or an air conditioning module of the cab 6 and/or one or more DC-DC converters for the electrical supply of further electrical equipment of the machine, for example a signalling light, a warning tone, etc.

The power distribution housing 50 is received in the box 5, in the example shown in FIG. 4.

As mentioned above, the electric propulsion motor 60 provides the propulsion of the machine 1. As visible in FIG. 4, an output shaft (not shown) of the electric propulsion motor 60 drives two shafts 62 and 63 via a reducer 61. The shaft 63 drives the rear axle 4 and thereby the wheels 4A, and the shaft 62 drives the front axle 3 and thereby the wheels 3A. The reducer 61 can have one or more reduction ratios. It is noteworthy that the shafts 62 and 63 extend in the longitudinal direction A-A of the machine 1 and thus parallel to the longitudinal members 10-1, 10-2. However, many other types of power transmission to the front axle 3 and rear axle 4 are possible. In particular, an electric motor can be provided for the front axle 3 and a further electric motor can be provided for the rear axle 4. It is also possible to provide that the electric motor 60 drives a hydraulic pump which in turn drives a hydraulic motor for the front axle 3 and a further hydraulic motor for the rear axle 4.

The electric actuating motor 70 in turn ensures the actuation of the lifting arm 20. According to one example, the electric motor 70 drives a hydraulic pump which supplies the hydraulic actuators, for example the hydraulic actuating cylinders, to actuate the movements of the lifting arm 20. The movements comprise, for example, the upward-downward movements carried out by a lifting cylinder located below the lifting arm 20, the extension-retraction movements carried out by a telescopic actuating cylinder located in the lifting arm 20 and the movements of the implement carrier. Such a hydraulic actuation of the lifting arm 20 is well known per se, so that it is not described in detail here.

As shown in FIG. 4, the power distribution housing 50 can comprise one or more chargers 53 making it possible to recharge the first and second electrical energy storage units 40A-40B.

Although the invention has been described in connection with several particular embodiments, it is obvious that it is not in any way limiting and that it comprises all of the technical equivalents of the means described, in addition to the combinations thereof if they fall within the scope of the invention.

The use of the verb “contain”, “comprise” or “include” and the conjugated forms thereof does not exclude the presence of different elements or different steps from those cited in a claim.

In the claims, any reference sign in parenthesis should not be interpreted as a limitation to the claim.

1. Handling machine (1) comprising:
a chassis (2);
a lifting arm (20) which is pivotably mounted on the chassis (2) in a median longitudinal plane;
a front axle (3) and a rear axle (4) which are fixed to the chassis (2);
a cab (6) which is designed to accommodate a driver, said cab being fixed to the chassis (2) and being positioned between the front axle (3) and the rear axle (4) and on a first side of the lifting arm (20);
at least one electric motor (60, 70) and
a first and a second electrical energy storage unit (40A, 40B) which are connected to the at least one electric motor (60, 70) and fixed to the chassis (2) on either side of the lifting arm (20), the first electrical energy storage unit (40A) being positioned to the rear of the cab (6) on the first side of the lifting arm (20) and the second electrical energy storage unit (40B) being arranged on a second side of the lifting arm (20), opposing the first side, at least partially opposite the first electrical energy storage unit in a transverse direction (B-B) at right-angles to the median longitudinal plane.

2. Handling machine (1) according to claim 1, wherein the first and second electrical energy storage units (40A, 40B) have a mass distribution which is substantially balanced relative to the median longitudinal plane.

3. Handling machine (1) according to claim 2, wherein the mass distribution is 50 to 60% on the side of the first electrical energy storage unit (40A) and 40 to 50% on the side of the second electrical energy storage unit (40B).

4. Handling machine (1) according to one of claims 1 to 3, wherein the first and second electrical energy storage units (40A, 40B) each comprise a plurality of electrolytic cells, the first electrical energy storage unit (40A) or the second electrical energy storage unit (40B) comprising a battery management system which is configured to monitor and control the electrolytic cells of the first and second electrical energy storage units (40A, 40B).

5. Handling machine (1) according to claim 4, wherein the battery management system is incorporated in the first electrical energy storage unit (40A), the number of electrolytic cells of the second electrical energy storage unit (40B) being greater than the number of electrolytic cells of the first electrical energy storage unit (40A).

6. Handling machine (1) according to one of claims 1 to 3, wherein the first electrical energy storage unit (40A) comprises a plurality of electrolytic cells and the second electrical energy storage unit (40B) comprises a battery management system which is configured to monitor and control the electrolytic cells of the first electrical energy storage unit (40A).

7. Handling machine (1) according to one of claims 1 to 6, wherein the first and second electrical energy storage units (40A, 40B) each comprise at least one temperature sensor and at least one device for measuring the charging state.

8. Handling machine (1) according to one of claims 1 to 7, wherein the first electrical energy storage unit (40A) is located in a longitudinal direction (A-A), parallel to the median longitudinal plane, between the cab (6) and a rear end (11) of the chassis (2) and is located in the transverse direction (B-B) between the lifting arm (20) and a lateral edge of the chassis (2).

9. Handling machine (1) according to one of claims 1 to 8, wherein the handling machine (1) comprises a box (5) which is configured to receive a plurality of pieces of equipment, the box (5) being positioned between the front axle (3) and the rear axle (4) and on the second side of the lifting arm (20), the second electrical energy storage unit (40B) being located in a longitudinal direction (A-A), parallel to the median longitudinal plane, between the box (5) and a rear end (11) of the chassis (2) and being located in the transverse direction (B-B) between the lifting arm (20) and a lateral edge of the chassis (2).

10. Handling machine (1) according to one of claims 1 to 9, wherein the electric motor is an electric propulsion motor (60) which is configured for the propulsion of the handling machine (1), and the handling machine (1) comprises an electric actuating motor (70) which is configured to actuate the lifting arm (20), the first and second electrical energy storage units (40A, 40B) being connected to the electric actuating motor (70) and the electric propulsion motor (60).

11. Handling machine (1) according to claim 10, wherein the handling machine (1) comprises a box (5) which is configured to receive a plurality of pieces of equipment, the box (5) being positioned between the front axle (3) and the rear axle (4) and on the second side of the lifting arm (20), the electric propulsion motor (60) being located between the front axle (3) and the rear axle (4) below the lifting arm (20) and the electric actuating motor (70) being located in the box (5).

12. Handling machine (1) according to one of claims 1 to 11, wherein the at least one electric motor (60, 70) is coupled to at least one of the front axle (3) and rear axle (4).
